(19) United States
(12) Patent Application Publication
(10) Pub. No.: US 2009/0113008 A1
(43) Pub. Date: Apr. 30, 2009

(54) Systems and Methods to Exchange Patient Information and to Set Up and Trigger Healthcare Alerts

(76) Inventors: Marcos Lara Gonzalez, New York, NY (US); Alberto Lopez Toledo, Barcelona (ES); Miguel Lara Gonzalez, New York, NY (US); Raul Rodriguez-Esteban, Cambridge, MA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/060,435

(22) Filed: Apr. 1, 2008

Related U.S. Application Data
(60) Provisional application No. 60/921,956, filed on Apr. 5, 2007.

(51) Int. Cl. G06F 15/16; G06Q 50/00

(52) U.S. Cl. 709/206; 705/3

(57) ABSTRACT

Systems and methods for sending health care alerts or reminders to patients, such as a reminder to visit the doctor, be vaccinated, or undergo a therapy. The alerts and reminders may be delivered to the patient's cell phone, PDA, or computer, for example. The system manages information of patients and/or caregivers who are eligible for a vaccine or therapy, but have not contacted their health care professional yet for an appointment or taken the vaccine. The system serves to increase the number of patients who will undertake a desired action to which the alert/reminder was directed, such as getting a vaccine, visiting the doctor, or obtaining the remainder of one's therapy, medication, or vaccine.

### RELATED APPLICATIONS

This patent application claims the benefit of provisional U.S. Patent Application Ser. No. 60/921,956, entitled Systems and Methods to Exchange Patient Information to Set Up and Trigger Healthcare Alerts, and filed on Apr. 5, 2007.

### FIELD OF THE INVENTION

The field of the invention is medical computer systems and more specifically, to new methods for exchanging information between the patient and a third party. The information exchanged will be used to set up and send (or trigger) alerts at patients' communications devices, including, but not limited to, wireless devices, handheld devices, telephones, and personal computers, reminding patients to come for a visit or comply with a vaccination or prescription schedule.

### BACKGROUND OF THE INVENTION

Immunizations are one of the safest and most effective ways to protect children from a variety of potentially serious childhood diseases. Ninety percent of people not immune to measles will contract the virus if exposed. If the measles vaccine was discontinued in the United States, three to four million measles cases would occur annually and result in more than 1,800 deaths, 1,000 cases of encephalitis, and 80,000 cases of pneumonia. Immunizations also are effective to protect adolescents and adults from a variety of diseases, such as influenza (the “flu”).

Currently, more than 20 percent of two-year-olds within the United States are missing one or more recommended immunizations. Parents may be unaware of vaccine requirements and believe their child is up to date when in fact the child is not. Clearly, new strategies need to be developed to protect children at risk.

Effective communications are a cornerstone of successful immunization strategies. Communications include education about the importance of vaccines and reminders or recalls. The Advisory Committee on Immunization Practices (ACIP), the American Academy of Pediatrics (AAP), and the American Academy of Family Physicians (AAFP) recommend the use of a reminder and/or recall system to increase vaccination rates.

Methods that combine the effectiveness of wireless devices (e.g. cell phones; from now on we will use “cell phones” and “wireless” as synonyms) with email and landlines provide an opportunity for improvement in the area of immunizations for a variety of reasons.

First, these technologies are low cost and can reach the vast majority of Americans in a cost effective fashion. In a recent study we conducted at Columbia University to evaluate cell phone/text messaging habits in young NYC women, a majority of participants had cell phones (70% of low income and 90% of middle high income) and 90% of users knew how to read and send text messages. The average cell phone user had her cell phone on 20.4 hours per day.

Second, these technologies are effective to improve immunization rates. For example, wireless text messaging (or SMS) is a technology that has successfully been used in clinical trials to improve vaccination rates up to 100%. To assess feasibility of SMS interventions Columbia University School of Public Health conducted a small text messaging pilot. We sent a series of 3 reminders and 2 recalls to pilot participants and obtained excellent results: 70% of the people who received messages gave their children a shot within two weeks of receiving the messages.

Third, these technologies allow for interactivity with the patients or caregivers and provide a low-cost method to monitor and get responses from patients.

However, the success of these technologies to improve vaccination in the real world has been limited. Hospitals and health plans that try to offer cell phone reminders for immunizations have found that, even though the method could work in theory, it is very hard to collect the necessary information to send the reminders.

The systems and methods described in the patent specification allow healthcare providers to collaborate with patients and third parties (e.g. pharmaceutical companies) to easily collect the patients/caregivers' contact information and to effectively send patient reminders.

### DETAILED DESCRIPTION OF THE DRAWINGS

The components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

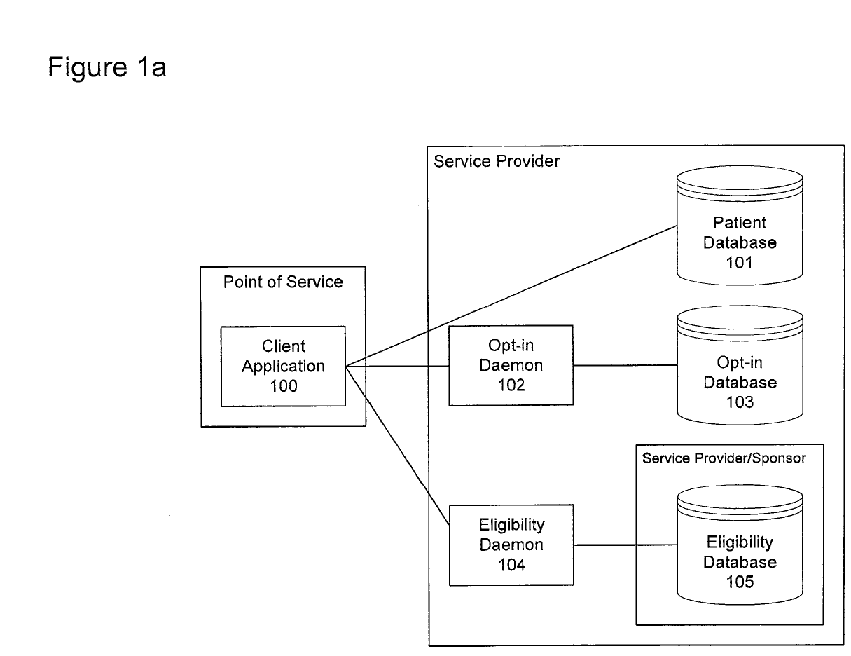

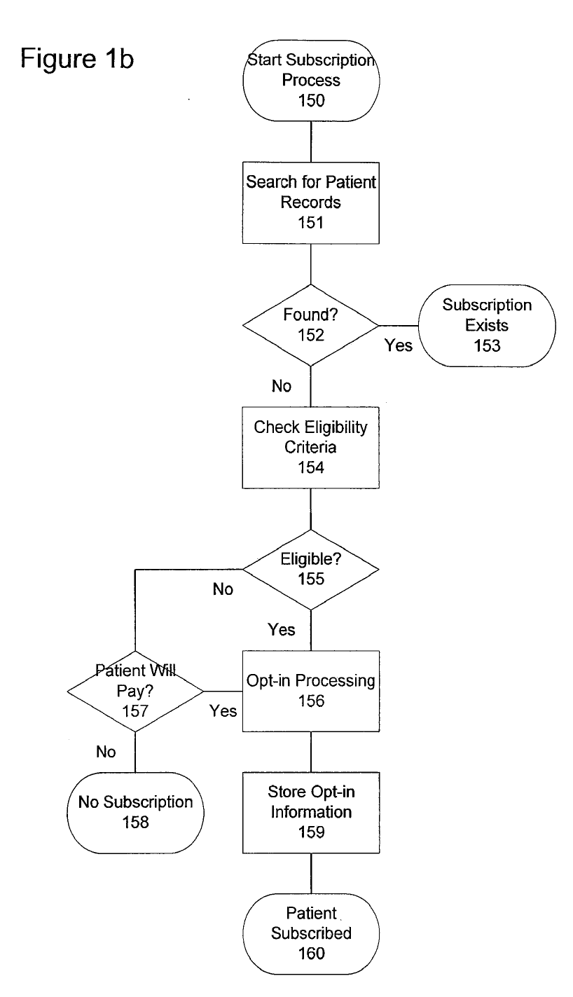

FIGS. 1a and 1b illustrate a subsystem and flowchart for subscribing patients and determining whether patients are eligible for sponsorship, in accordance with an embodiment of the present invention.

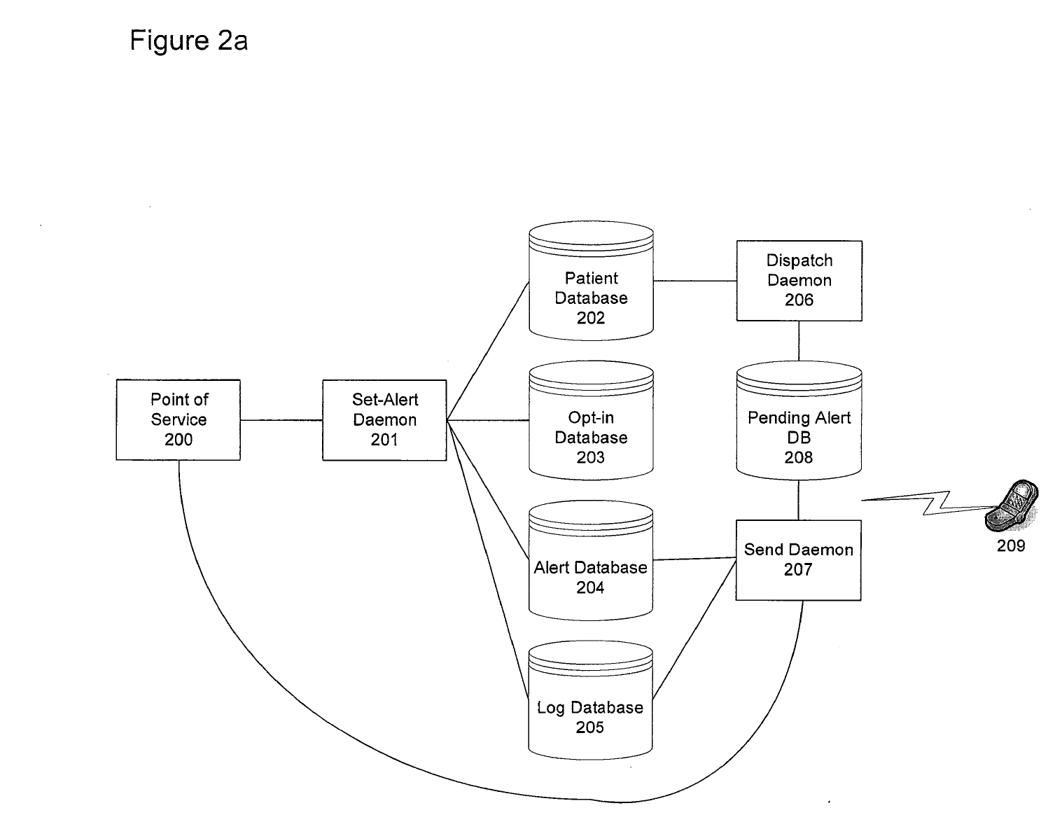

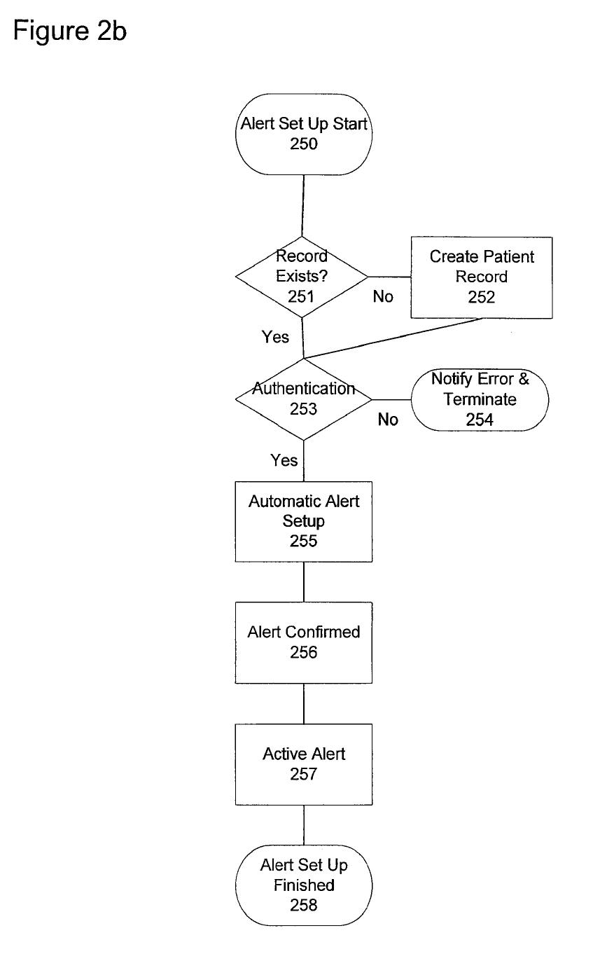

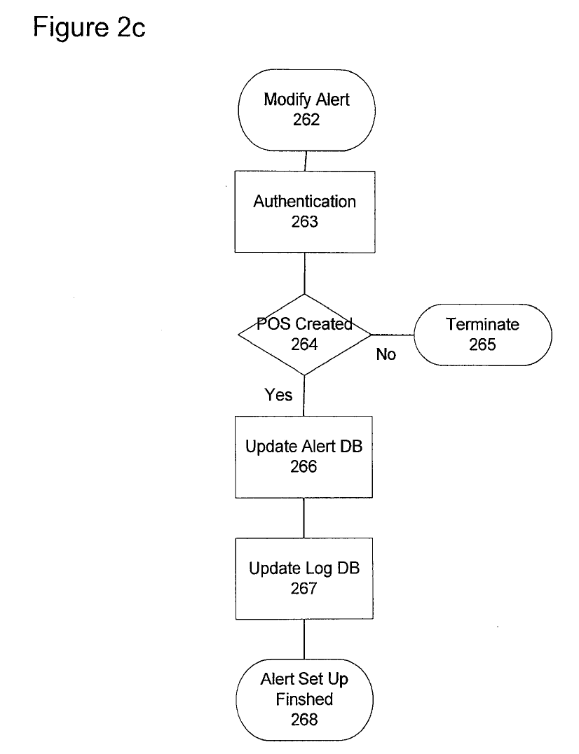

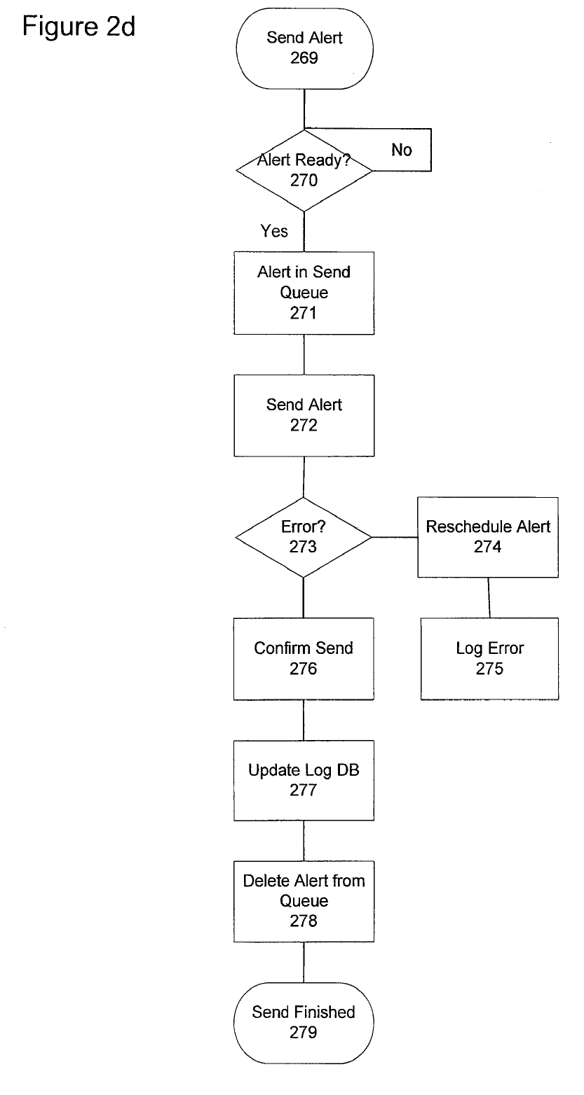

FIGS. 2a through 2d illustrate the operation of the subsystem for setting up, modifying, and transmitting alerts, according to an embodiment of the present invention.

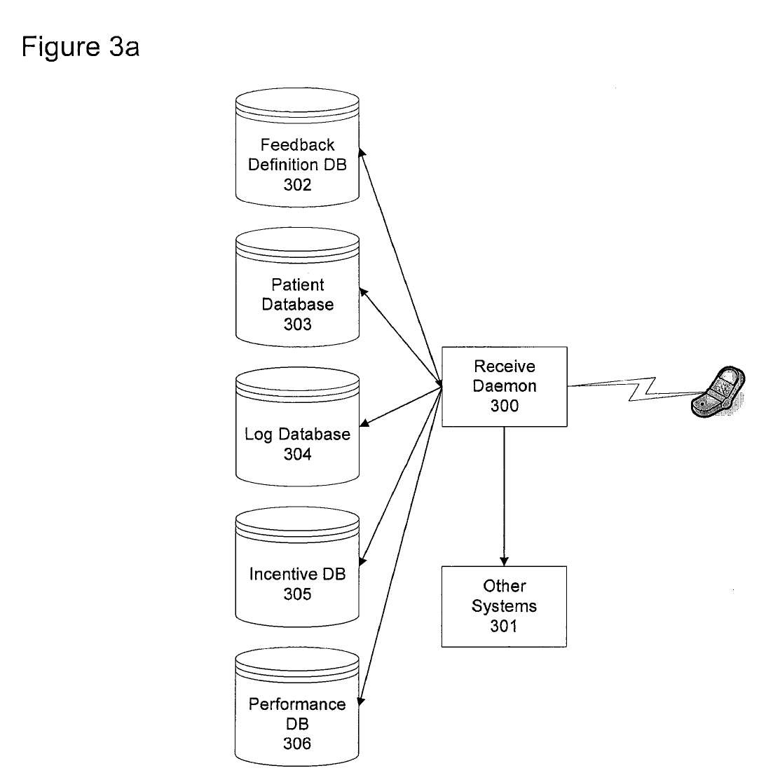

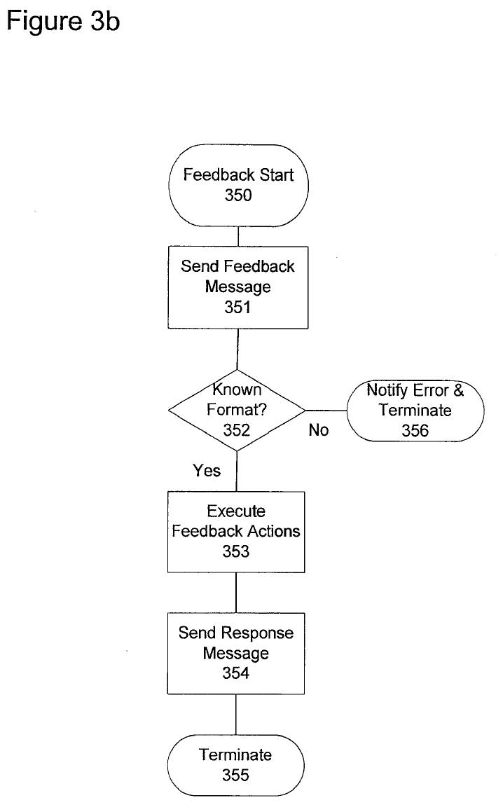

FIGS. 3a and 3b illustrate the system and process for patients to provide feedback in accordance with an embodiment of the present invention.

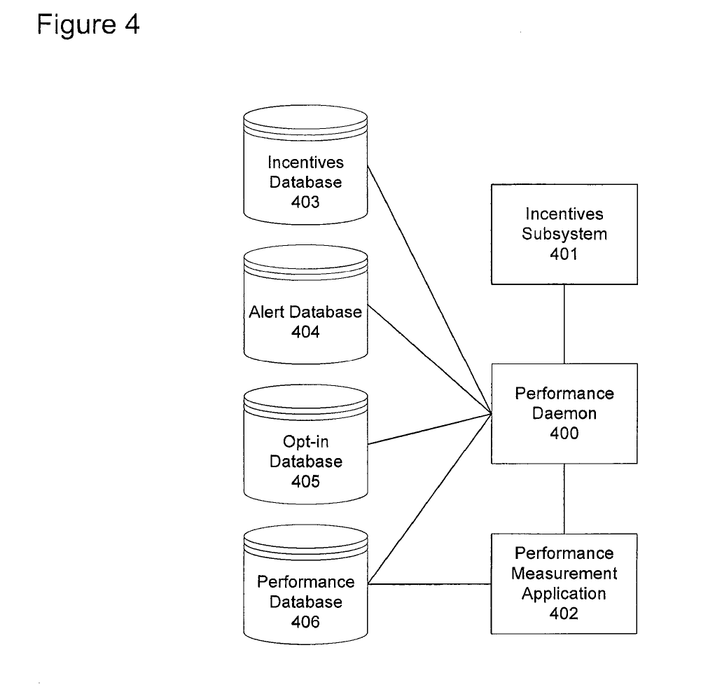

FIG. 4 illustrates the performance measurement system in accordance with an embodiment of the present invention.

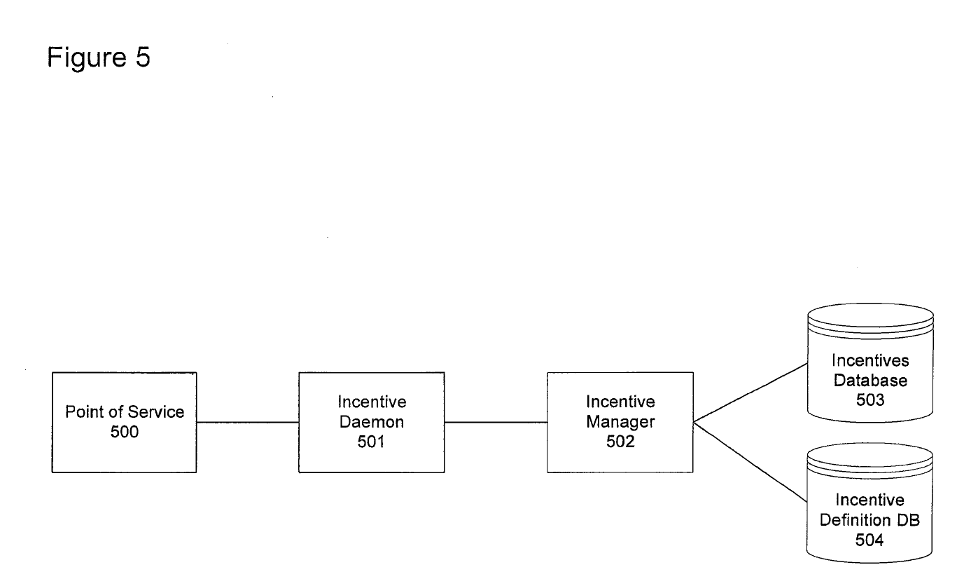

FIG. 5 illustrates the incentive subsystem in accordance with an embodiment of the present invention.

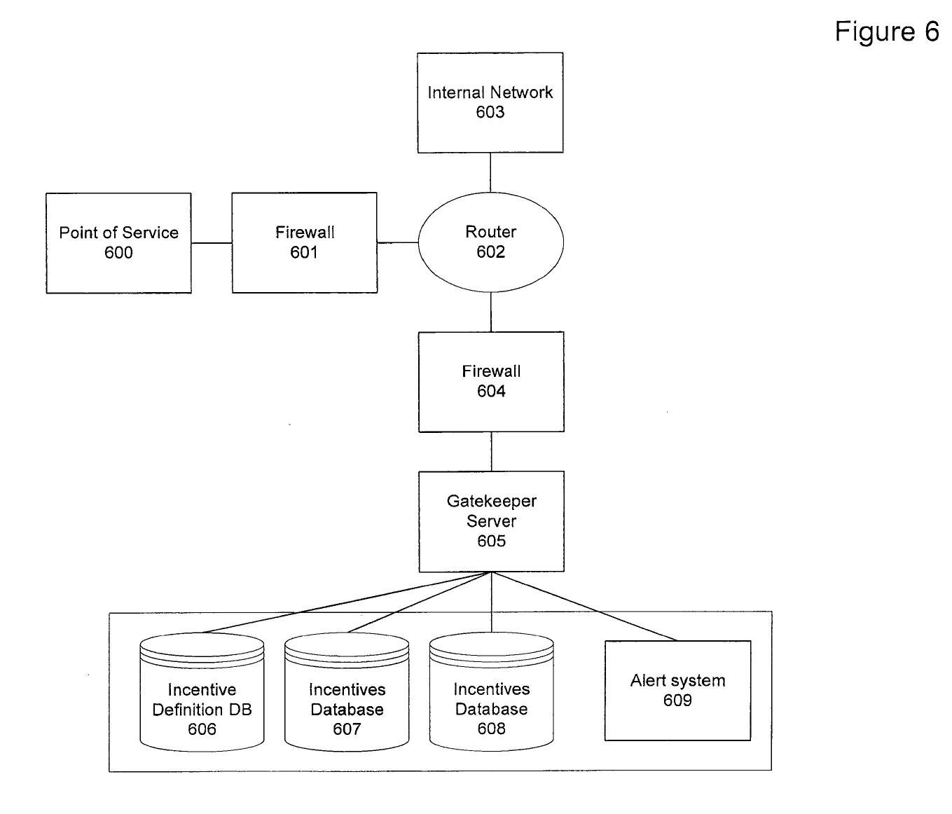

FIG. 6 illustrates the security system according to an embodiment of the present invention.

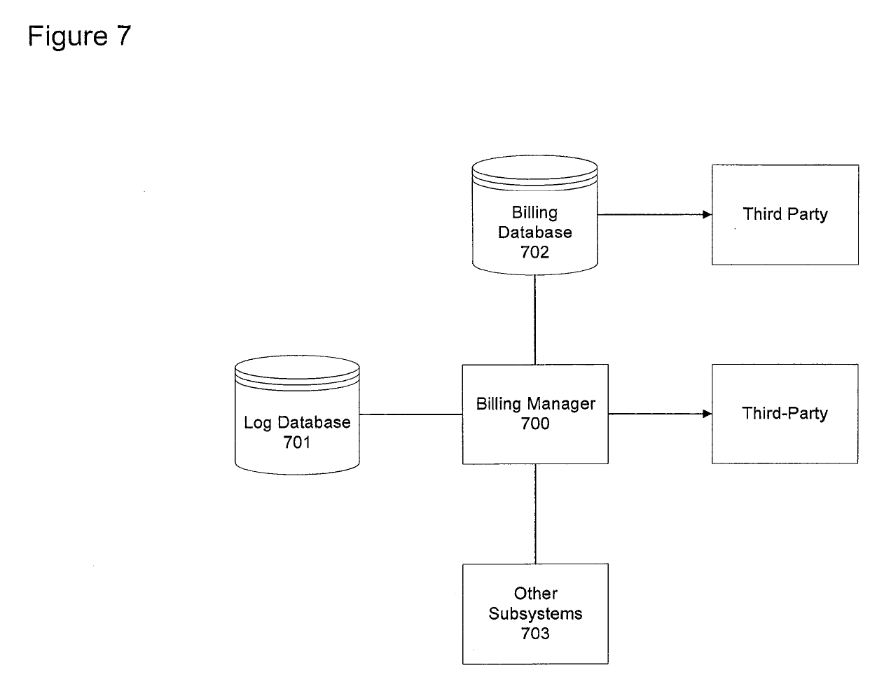

FIG. 7 illustrates the billing subsystem according to an embodiment of the present invention.

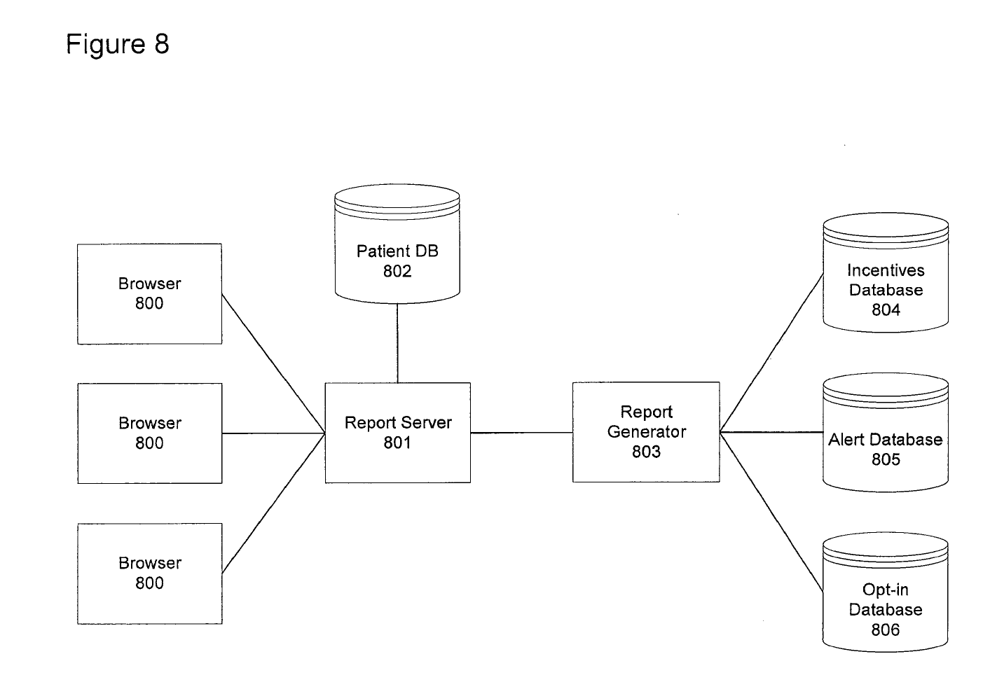

FIG. 8 illustrates the patient remote access system according to an embodiment of the present invention.

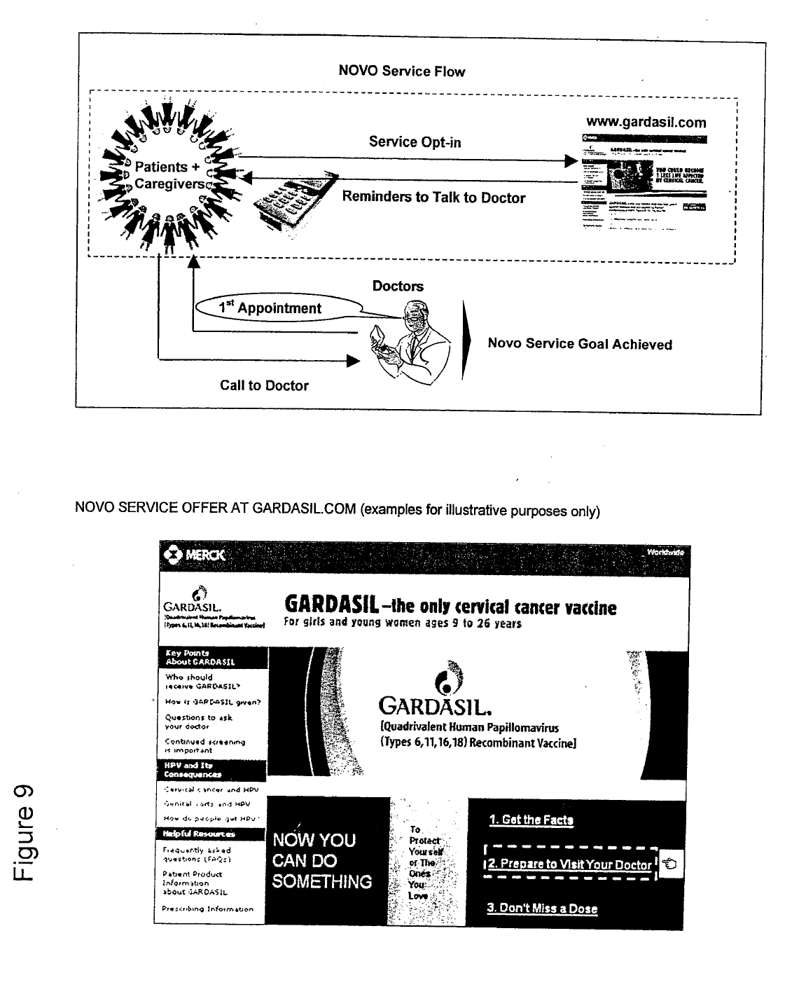

FIG. 9 illustrates an example of a flowchart of an embodiment of the NOVO method.

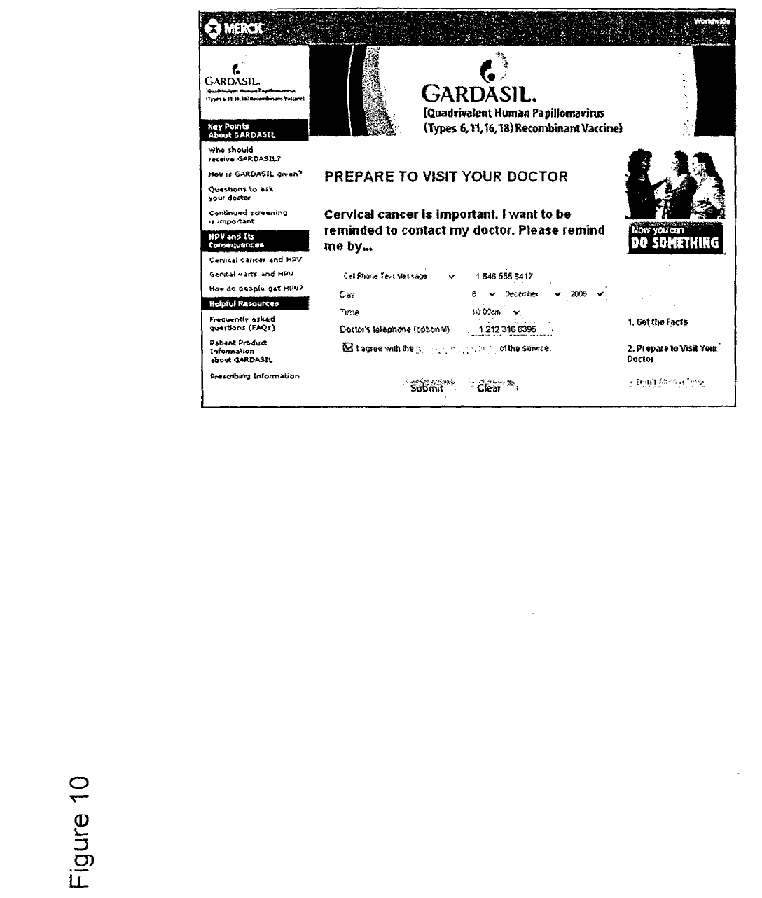

FIG. 10 illustrates an example of a website participating in an embodiment of the NOVO method.

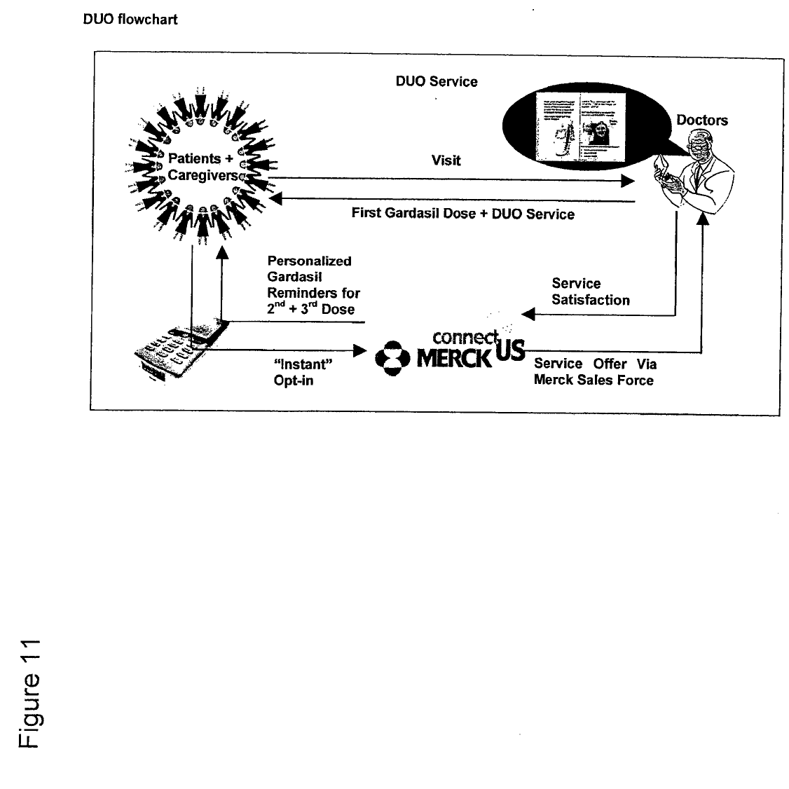

FIG. 11 illustrates an example of a flowchart of an embodiment of the DUO method.

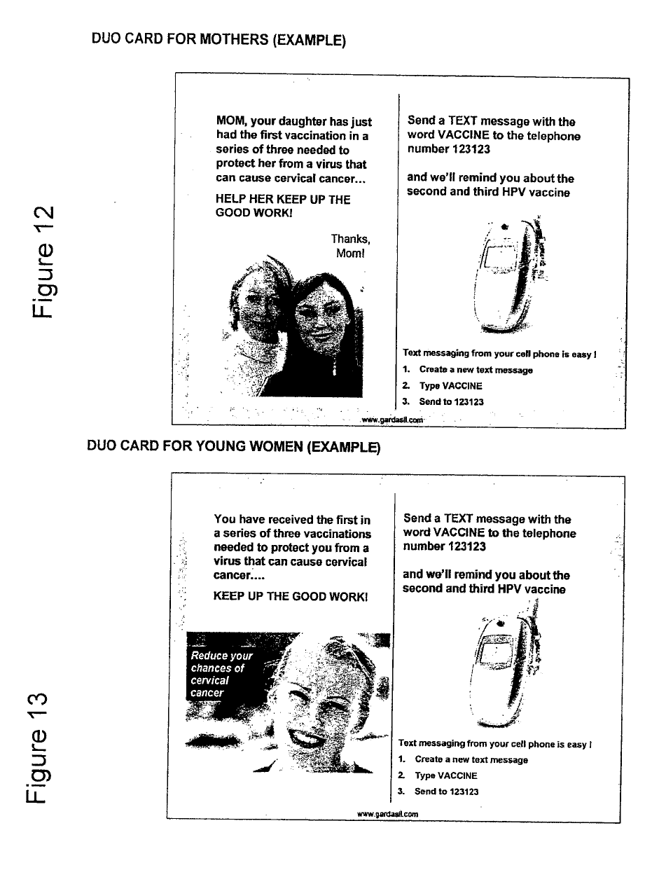

FIG. 12 illustrates an example postcard for methods, according to an embodiment of the DUO method.

FIG. 13 illustrates an example postcard for young women, according to an embodiment of the DUO method.

In order to better appreciate how the above-recited and other advantages of the present inventions disclosed herein are obtained; a more particular description of the improved methods and system briefly described above will be rendered by reference to specific embodiments thereof, which are illustrated in the accompanying drawings. These drawings depict only typical embodiments of the invention and do not therefore limit its scope. The embodiments of the invention will be described and explained with additional specificity and detail, including through the use of the accompanying figures.

### SUMMARY OF THE INVENTION

The patent specification describes two method embodiments of the invention and a shared system embodiment, whose goal is to exchange information between patients and caregivers and a third party to set up and send (or trigger) a heathcare alert. Although in the preferred embodiment, the invention is used to exchange information that creates immunization reminders, the systems and methods presented can be used for any other medical purpose, such as a medical appointment, screening or therapy.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DETAILED DESCRIPTION OF THE PREFERRED EMBODIMENT

A high level overview of the methods and systems in the preferred embodiment is presented, and then a detailed description of the system and its operation is discussed.

### Overview:

The first method embodiment (hereinafter also referred to as the “NOVO” method) collects and manages information of patients and/or caregivers who are eligible for a vaccine or therapy, but have not contacted their provider yet for a first appointment.

The NOVO method's goal is to increase the number of patients or their caregivers who will call or visit a doctor after visiting a healthcare website. In this patent specification, patients and/or their caregivers who sign up for a healthcare alert are referred to as “subscribers” to the improved healthcare alert method. For simplicity, “patient” may refer to the patient or a caregiver for the patient. Patients browsing the website may get interested in talking to their doctors while visiting the site. However, the intention to call does not always translate into a real call. They may visit the website when the doctor's office is closed (e.g., nights, weekends) or not have the provider's telephone handy.

The NOVO method provides a solution to this problem by allowing patients/caregivers to set up personal reminders from the website (either as email, wireless message, voice message) that will be received at a later time (normally when the website visitors have determined they can effectively make the call to their doctors).

In the NOVO method, patients (and sometimes doctors on behalf of the patient) and/or doctors will visit a healthcare website, ideally a drug manufacturer's product web site. The method also uses a system (the “SYSTEM”, as further described in this patent specification) available at or accessible from the website capable of setting up the personal reminders to be received later by subscribers. Other methods of accessing the system are possible, such as Interactive Voice Response (IVR) calls or involving the sending of a text message from the patient, specifying the required details for the system to work.

The second method embodiment (hereinafter referred to as the “DUO” method) is designed to provide doctors and healthcare organizations with an easy method to collect patients' contact information that can be used for patient alerts. Patients learn about the method during the doctors' visits and the alerts can be set up then or at a later time.

In the preferred embodiment of the DUO method, the DUO method is operated by a third party, such as a pharmaceutical company or subcontractor, which provides service to a group of healthcare providers of any size. In this embodiment, the DUO method requires that doctors receive from the third party information on how to subscribe to a service reminder (e.g., a particular phone/pager number or address that patients will be able to reach and provide at least one type of contact information, such as their cell phones). One possible way for the doctor to receive the subscription directions is from the third party's sales force (e.g., pharmaceutical representatives), who would provide this information to doctors via handout, e-mail, e-detail, or any other support. Doctors or staff will facilitate this number to the eligible patients. In another embodiment, the patient or caregiver device directly synchronizes his/her device with some other device at the doctor's office and downloads directly the alert information. This device has been provided or set up/activated for the doctor with help of the third party.

In another embodiment, the patient who sends his/her contact information to the third party receives one download with all the needed alerts set up at once, as opposed to receiving several individual alerts.

Embedded in the methods, the SYSTEM is able to process messages coming from a patient, caregiver or healthcare provider who wants to set up reminders and use the information received to create the reminder series.

The main advantages of the DUO method are its immediacy and simplicity. In the preferred embodiment of the DUO method, reminders are set up when patients are at the doctor's office using a wireless device and they are sent right when the patient needs them to maintain focus on the therapy. In this same embodiment, a message sent by a patient with just one word, short sentence or code is enough to activate a full series of personalized reminders. However, the DUO is versatile and other embodiments allow the doctor's staff to set up the reminders for the patient. Patients who do not have a cell phone or a third party assisting them can also use the information they received from their providers to set up the service at a later time (e.g., call home from their land line telephone). In most cases, patients can decide whether they want to receive a wireless text message, voice or email reminders.

Messages sent to patients can optionally combine educational tips that engage patients and also request patient feedback. For example, a message may say: “Dear Heather, please let us know if you contacted your provider with regards to the second HPV vaccine. Reply 1 if yes or 2 if you are still working on it. Thanks”. Any information sent by patients or doctors that are formerly available or identifiable by the third party (e.g., name, age, interests, doctor code) can be used to personalize the reminder content later on. The feedback sent by patients can also be used for other purposes, such as measuring the performance of the reminder method for vaccination (such as compliance rate), and to tailor the response of the System in order to be more effective for the patients. This information can also be made available to doctors and caregivers as a way of monitoring the patient, and can significantly improve the response of the doctors (due to its immediate availability) and the welfare of the patients.

In the preferred embodiment, the System uses the DUO and NOVO methods to collect patient information and generate vaccine reminders to help patients get properly immunized. For illustrative purposes, we have chosen the HPV vaccine as an example used in the preferred embodiment, although the concept could be applied to any other vaccine, screening or therapy.

The HPV vaccine can protect women from 70% of the virus that cause cervical cancer, which is the second leading cause of cancer among women. The HPV vaccine needs three doses to fully immunize women against the HPV virus. There is currently only one vaccine in the market, Gardasil manufactured by Merck, available to protect women against HPV. In the preferred embodiment, the Gardasil website offers the option to set up reminders online to contact the doctor. This reminders can be sent via text message/MMS, voicemail or email (NOVO service). The website is connected to the System, which sends reminders whose goal is to remind patients/caregivers to call the doctor for their first appointment. A flow chart of the NOVO method and an example of the website are provided in FIG. 9.

Also in the example preferred embodiment, Merck's sales force would utilize the DUO method and hand out to doctors postcards with a short code or 1-800 toll free number where patients can call or text from their cell phones. Doctors give these postcards to patients/caregivers during the visit in which they are receiving their first dose of HPV vaccine. At this point, patients send a text message, which is received by the System and processed. If the short code 123123 is dedicated to HPV vaccines reminders and assuming that the first dose was received around the date that the message with the word vaccine was received, the System calculates when the second and third doses are going to be due. If the short code was not dedicated to one product only, then further information should be included in the first message or in subsequent ones. For example, a message containing the string HPV.Ann.29, means that the person is named Ann, age 29 and has written to receive reminders for her second and third dose of HPV vaccines. Thus, the system may infer that Ann is a caregiver (if the vaccine is only for ages 9 to 26) and the System can personalize the content of the reminders according to this information. Additionally, the System can send questions after the person has opted in to be able to tailor the messages better or to determine if the patient has performed an action or needs help. The System can also know by receiving a code (e.g., a personal preassigned code to doctors offering the system), the doctor's name and telephone number to be included as part of the message content when the reminders are sent. Thus, the code 1234567 could be interpreted by the system as Dr. Hyman and his telephone number is 212 345 6789. This code or a similar code/word can be used to specify the language in which to send the reminder (e.g., English, Spanish, French).

A flow chart of the DUO method and an example of a postcard are provided in FIGS. 10 and 11. Additional examples of cards for use with the DUO system are provided in FIGS. 12 and 13.

Although the description of some embodiments is focused on wireless alerts, the System is not limited to wireless alerts and may also be able to download information directly to a patient device, with or without the alert activation coupled to the information download. In addition, reminders may be provided on other channels such as e-mail, automated phone calls, or multimedia messaging. The System may also be used to improve the quality of veterinary care of animals.

### Detail:

FIGS. 1a and 1b illustrate the structure and operation of the subsystem for subscribing patients including determining whether patients are eligible for sponsorship in accordance with an embodiment of the present invention.

The subscription process begins at step 150 when the patient or a caregiver sets up reminders at a point of service, such as at a wireless device or website. The point of service employs a Client Application 100 to interact with the alert system and subscribe the patient to the service. The Client Application 100 may be a standalone application, a browser or an add-on to a commercial product.

In step 151, the Client Application 100 checks to see if the patient's alert preferences, prescription history, patient contact information (such as cell phone) or other pertinent data have already been stored in the Patient Database 101. If patient information is found in decision block 152, the patient is already subscribed in the system and no further processing is necessary, the process terminates at step 153, and a new alert may be set up for the patient.

If the patient has not yet subscribed to the alert System, patient information will not be found at decision block 152, and the point of service must collect information about the patient, including where to send alerts (e.g., a cell phone number or email address) as well as other alert preferences, such as whether the patient wishes to receive health education updates. If the system is activated via a wireless text message, the information can be extracted from the message itself, such as cell phone, and any other information contained in the text. Other information may include the patient's Social Security Number, insurance information, medical records, the patient's risk profile, eligibility criteria, or specific information related to performance studies that the patient is participating in. Some of this information may be collected at time of enrollment, and some may be added later in conjunction with setting up certain reminders or in association with other events. In a simple embodiment, the System will acquire the patient's cell phone number from the wireless sender number and vaccination information from a code sent by the user. In the case of the DUO method, described above, the code can be obtained via the DUO cards or by any other mean as shown in the description of the method. This information will be stored in the Patient Database 101.

In an embodiment of the System, the point of service may check patient eligibility for sponsorship, if needed, in step 154. Criteria for eligibility may include a patient's doctor, insurance carrier, patient demographics, prescription information, type of service or drug, or a specific promotional code that may render the service free. The criteria may be stored in an Eligibility Database 105 at the service provider, or at a sponsor organization, such as a health maintenance organization, pharmacy benefit manager, drug company, or insurance company. The Eligibility Daemon 104 will receive an eligibility query and will check, at decision block 155, to see if a particular patient is eligible by searching in the Eligibility Database 105. Sponsorships may be offered by the patient's health insurer, pharmacy benefit manager, or drug companies. If the patient is not eligible to receive the sponsored service, the patient may choose to pay for the service instead at decision block 157.

The Opt-in process occurs in step 156. Because of the highly regulated nature of the health care sector, and the possible liability associated with service failure, it is necessary to obtain specific permission from the patient to be enrolled in the reminder service. The opt-in will include informed consent by the patient to participate in the system, notification about the possible consequences of doing so, and a waiver of liability for patient misuse of the reminder system. The opt-in may also include privacy notices and any other notices regarding studies the patient may elect to participate in. The Opt-in Daemon 102 at the service provider receives the opt-in information and stores it in the Opt-in Database 103. The opt-in must be obtained during initial enrollment and checked every time a new alert is set up in order to mitigate liability risks. In a simple embodiment, the message a patient sends to start the service may be used as opt-in acceptance and service notices, including disclaimers and other information (such as opt-out methods) would be subsequently sent to the patient. As with any of the databases described herein, the patient database 101, opt-in database 103 and eligibility database 105 may be combined into one or more databases.

Once this process has been completed, in step 160, a patient has been subscribed for the alert service and the service provider may create alerts for the patient. Additionally, patients can be enrolled by their primary caregivers but because the patient has been enrolled with a particular service provider, the reminder service may be set up by different caregivers. New alert setups may require the patient to repeat some or all of the steps above, such as opt-in verification and eligibility checking.

FIGS. 2a through 2d illustrate the structure and operation of the subsystem for setting up, modifying, and transmitting alerts, according to an embodiment of the present invention.

The Patient Database 202 stores information about each patient registered with the system, such as the patient's Social Security Number and information about how to contact the patient, such as a cellular number or email address. The Patient Database 202 may also include other information about the patient such as compliance rate, health provider, or incentive or performance data.

The Opt-in Database 203, as described above, stores opt-in information for each patient that is subscribed to use the system. This information confirms that the patient has consented to receive alerts and has waived any potential liability.

The Alert Database 204 includes information about each alert that will be sent by the system. The Alert Database 204 includes a unique identifier for each alert (ALERT_D), the destination of the alert (ALERT_DEST), the alert message (ALERT_MSG), and the delivery schedule for the alert (ALERT_SCHEDULE). The Alert Database 204 may also include alternative means for contacting the patient, a patient identifier, prescription information, or health insurance information.

The Log Database 205 stores information about what operations the system has conducted for billing, auditing, or other purposes. The patient database 202, opt-in database 203, alert database 204, log database 205 and pending alert database 208 may be combined into one or more databases.

To set up an alert, the patient or a caregiver at the point of service must log in to the system in step 250. The login process can be performed by the patient or the caregiver, by calling a particular phone number, sending a text message to a particular number or logging into a website, as long as the information entered is sufficient to identify the patient. Once the patient or caregiver has logged in, the system checks to see if the patient for which the alert is being created already exists in the Patient Database at decision block 251. If not, an entry for the patient's information is created and the information is entered into the database in step 252. The system must also check the Opt-in Database to verify that the patient has elected to receive reminders at decision block 253. If a proper entry is not found in the Opt-in Database, that information must be supplied, or the system will not permit alerts to be set for that patient and will terminate at 254. In a simpler embodiment of the system, a patient-initiated message can also serve as opt-in acceptance (as described above), and service notices, including disclaimers and other information (such as opt-out methods) would be subsequently sent to the patient.

Once the patient and opt-in information have been confirmed, the system will set up an alert in the Alert Database 204. The information needed for the alert may be automatically extracted from the prescription or vaccine information in the input data (destination short code, contents of the message, specific codes, etc.), such as checking for reminder type information in step 256. The prescription or vaccine information may include the prescribing physician, specific information about the drug regimen, and recommendations for the patient, either generically or tailored to a doctor's patient needs. The Set-Alert Daemon 201 processes the alert information and stores it in a suitable format in the Alert Database 204. For instance, a single vaccine or prescription may generate multiple reminders which will correspond to multiple entries in the Alert Database 204.

The reminder System may also include a set of templates to aid the setting up the proper reminders for known vaccination schedules or drug regimens. The System may also allow the operator to combine reminder messages if the patient will be taking several vaccines or drugs in order to reduce the number of reminder messages received by the patient. In step 256, the service provider will confirm to the point of service when the alert has been set up.

Alert information is transmitted to the service provider in an alert message comprising a number of fields describing the alert characteristics: the name of the vaccine or medicine, the doctor, the times and dosages for taking the prescription, the number of doses, additional medical advice and other options such as if the patient wants to receive general health care advice. This alert message is received by the Set-Alert Daemon 201 in the service provider, which is an application generally polling one of the ports of the network memory space of a computer. The Set-Alert Daemon 201 parses the incoming messages and stores them in the Alert Database 204.

The modification of alerts is shown in FIG. 2c. The system also permits a point of service 200 to alter alerts that it has already created. To modify an alert, a point of service must first authenticate itself to the service provider in step 263, similar as described above in connection with the creation of an alert. Once logged in, in step 263, the point of service may request the modification or deletion of any alert in the Alert Database 204. The system must first verify that the specified alert was created by this patient or caregiver by checking the point of service wireless number or the user's password, or any relevant information that identifies the user in step 264. If the point of service or patient/caregiver is authorized to change the alert, the Set-Alert Daemon 201 will process the request and modify or delete the corresponding entry or entries in the Alert Database 204 in step 266. Finally, the modification or deletion is recorded in the Log Database 205, for auditing or billing purposes in step 267.

Referring to FIG. 2d, once the alert is established in the Alert Database 204, the Dispatch Daemon 206 may check periodically to see what alerts need to be sent in decision block 270. When an alert is due, the Dispatch Daemon 206 places the alert in a queue to be processed by the Send Daemon 207 in step 271. The Send Daemon 207 interfaces with one or more telecommunication service providers and sends the alert in an appropriate form (e.g., an email, voice message or text message) in step 272. The system communicates with a telecommunications service provider via protocols such as TCP/IP, MMS/SMS, SIP, or SMTP. The connection to the communication provider may be through any number of physical media, including ADSL, ISDN, cable modem, or frame relay.

If there is no error in sending the message at decision block 273, delivery of an alert may be confirmed by the telecommunication service provider in step 276. When confirmed, the Send Daemon 207 will update the Log Database 205 in step 277 (e.g., for billing purposes) and delete the alert from the Alert Database 204 in step 278. In the case of an error at decision block 273, the Send Daemon 207 will mark the alert as faulty, cause the Dispatch Daemon 206 to try again later in step 274 (e.g., by rescheduling the alert for 10 minutes later), and log the event in step 275. Eventually the alert will reach the patient, and a confirmation of receipt may also be sent to the Point of Service 200.

In accordance with an embodiment of the present invention, the system may be designed to handle high traffic load. The Alert Database 204 may be replicated and load balanced and multiple Send Daemons 207 may be used to simultaneously handle reminder transmissions. Each instance of the Alert Database 204 may serviced by a different Dispatch Daemon 206 and each of these Dispatch Daemons 206 may place pending alerts in a Pending Alert Database 208. Multiple Send Daemons 207 may then retrieve messages from the Pending Alert Database 208 and send them to one or more telecommunications providers 209 in parallel.

FIGS. 3a and 3b illustrate the structure and process for patients to provide feedback in accordance with an embodiment of the present invention. Any of the databases may be combined into one or more databases. The alert System can receive feedback information from the patient. The patient may independently send a feedback message or the patient may send a feedback message in response to an alert. The Receive Daemon 300 receives all feedback messages from the patient. The Receive Daemon 300 stores any feedback messages in the Log Database 304. A patient feedback message may also trigger an update of the information in the Patient Database 303, for example, to update compliance information in the Patient Database 303 when the patient replies to an alert with a confirmation of compliance.

When the System receives a feedback message sent from a patient in step 351, the System checks the message format in the Feedback Definition Database 302. If the message format is correct at decision block 352, the System will issue an error message and terminate, in step 356. If the message format is correct at decision block 352, the System will interpret the query and trigger the corresponding actions in step 353. These actions may be logged in the Log Database 304 in step 354 and may also generate information for the Incentive 305 or Performance 306 Databases. For example, the user may send the message “ALERT OFF,” requesting temporary deactivation of the alert System. In this case, the Receive Daemon 300 would check in the Feedback Definition Database 302 for messages of the form “ALERT ON/OFF” and would interpret the query and trigger the subsequent actions, such as logging, deactivation of the alerts or communication with external subsystems such as the incentive or performance engines. The System may also respond to feedback messages in step 354 by sending response messages to the patient. These responses may be handled as regular outgoing alerts or by other means after processing of the feedback message. The System may have certain feedback messages parameterized so that pre-configured responses are sent to the patients.

FIG. 4 illustrates the structure and operation of the performance measurement subsystem in accordance with an embodiment of the present invention. Patients are informed by their caregivers or in opt-in forms that the alert System may be used for the purpose of improving their health and the general well-being of the population at large. This includes the use of alert statistics to track compliance and to follow-up on the patients' fidelity to the System (e.g., vaccination rate, fill, refill, feedback, coupons, other information). The System stores opt-in information for each patient in the Opt-in Database 405. Opt-in information is sent either with text messages, electronic signatures, or other methods of validation. Current alerts information is stored in the Alert Database 404. Since this database 404 stores only active alerts, it is necessary to keep track of the alert history of a particular patient in order to conduct performance studies related to that patient. This can be done by the Performance Daemon 400. The Performance Daemon 400 may regularly query the Alert Database 404 to collect information about a selected set of patients. The importance of regular polling comes from the fact that alerts may be changed either by the patients or other users that are authorized such as relatives or caregivers. The Performance Daemon 400 ensures changes to the alert data recorded by regularly querying the Alerts Database 404 and updating information in the Performance Database 406. As with all databases in the embodiments, any or all of them may be combined into one or more databases.

Selected information from the Alert Database 404 and Opt-in Database 405 are stored in the Performance Database 406 in a set of tables. One table contains information about the patients for whom performance is being measured. The database may include a field called PATIENT_ID as well as other fields storing other information about the patient. A second table contains alert and opt-in information for each patient being monitored by the performance system. This table could include fields such as PATIENT_ID, DAY_SET, VACCINE/MEDICINE, and DOCTOR.

Finally, a set of tables representing lists of patients in different studies could be optionally included. These tables would each represent a specific performance study that is being carried out. Another important component for performance studies would be the Incentives Database 403. The Incentives Database 403 includes information about specific incentives given to patients and in which dates and under which terms.

A Performance Measurement Application 402 can run queries over the data stored in the Performance Database 406 and other databases of the System. It can generate reports containing alert, incentive, and opt-in information about groups of patients under study. These reports can be compared to control groups in comparative studies.

The System can also send alert messages to patients requesting demographic data. The alert would explain the reason for collecting the data, and if the patients provide a response, it can be stored in the Alert Database 404. The Performance Daemon 400 would gather this data during its queries of the Alert Database 404 and store it in the Performance Database 406.

The performance measurement subsystem may incorporate data from numerous sources including pharmaceutical companies; health care institutions like PBMs, that receive the reimbursement claims for one patient regardless of the pharmacy or hospital at which the patient was treated; information coming from HMOs, physician (e-prescriptions, etc), Medicaid/Medicare, vaccination registries, or other parties could be used as sources if their information meet certain requirements. If historic patient information is available, it can be used to compare patient's pre- and post-interventions. Otherwise, a record of vaccinations, as well as fill and refill information, will be created as the patient receives new vaccination or drug prescriptions. Data may come directly from the patient, the caregiver, the point of vaccine administration or of sale of a medication, or from an existing database that previously stored the required information such as a hospital or PBM database.

In an embodiment of the invention, the performance measurement application may perform various analyses on the available data and may compare data between a study group using the reminder service and a control group that does not. For instance, the performance measurement subsystem could collect information relevant to the study (such as the vaccination rate, or satisfaction level) of two or more cohorts with a certain demographic profile. The first cohort (intervention) could be subscribed to the reminder service. The second cohort (control) is either patients not subscribed to the program or the same intervention group before they enrolled to the reminder service.

The performance measurement application could then compare control and intervention groups to find statistical differences in the prescription vaccination and measure the impact in compliance and sales generated by the reminder service. The System can also measure health care savings associated with the program or any other metric available that is considered adequate.

In an embodiment of the invention, the performance measurement subsystem could also estimate sales indirectly by measure the satisfaction and compliance rates through feedback coming from patient responses. Using this information, the performance measurement subsystem could generate reports that allow managers to monitor the service performance. The subsystem could measure the difference in vaccination of patients grouped in categories including but not limited to: vaccine type, channel, and demographics.

The performance measurement subsystem may need to collect various types of data to support various performance studies. Data that might be collected includes: prescription and vaccination history; reminder service enrollment information, including the date of enrollment; a tag to classify the patient as belonging to a certain cohort or group (e.g., such a tag could be based on the vaccine name, age, gender, etc.); personal identifying information (e.g., Social Security Number, address, name, cell phone number, email address); information related to the Risk/Expense profile of the patient (e.g. high risk, high spender); feedback information from the patient provided through the reminder service; or when the patient's vaccination was due.

For sponsors that are willing to pay to increase compliance, the performance measurement subsystem may also provide the sponsors with a mechanism to estimate the benefits of their sponsorship. The sponsors may be willing to pay for the messages if they have a clear understanding of the benefits (e.g., margins) they are getting, and hence the possibility of financing the program (e.g., pay for the wireless messages). One possible way of measuring the impact is to encourage (by some incentive system) patients to send feedback about their compliance by responding to the messages using the feedback system described above. The analysis may be done by selecting two groups, one using the wireless reminders and another that does not.

The reminder and incentive services are ideally offered to doctor's patients, or members of other HC service providers, as they usually have regular communication with the patients. The two groups would allow a comparison of the vaccination rate and the efficiency of the method, estimate the increase of sales, hospitalization cost savings and even reduction in sick day cost for companies. Moreover, the feedback channel allows patients to respond to the reminders, providing data to perform detailed analysis of timing parameters when regarding compliance (e.g. time in responding to the reminder, time of day which is more likely for the patients to be responsive, amount of reminders that are successful, and even correlations between reminder success and specific vaccines). The reminders may contain other types of information such as marketing (tailor made) and advertisement that may help their financing, educational contents to address part of the passive non-compliance population, or even information about other compliance programs to inform the patients about other available incentives. Finally, it also allows patients to have a feedback channel with the service providers, for example to formulate questions or give any other type of information that may help in the analysis. Note that this channel is very powerful and may help to greatly improve the result of the compliance analysis and the accuracy of the estimates obtained through it.

The following are examples of how the performance measurement subsystem may analyze information to estimate various performance metrics for the sponsors and service providers, as well as other parties. The analysis is performed using two groups, a control group and intervention group that receive reminders from the reminder service. The data analysis might show that, on average:

Group A gets vaccinated 2.4 times out of a program total of three times and group B gets vaccinated 1.4 times out of a program total of three times. The price of the vaccine dose is $50, so the patient generates $50 in gross revenue. The cost of the messages is $0.50 per patient per vaccine, so the total cost is $1.50 per vaccination program. The marginal cost of the vaccine is $5. As a result, each patient subscribed to the System generates on average $43.50 of extra sales to the value chain; the drug manufacturer gets 80%; the wholesaler gets 3%; the pharmacy gets 17%, in addition to the additional visit to the doctor, and allows extra communication with the caregiver.

Vaccination rates are analyzed for a group of individuals. Data may be coming from doctor records available at hospital or insurance databases. For each individual, the number of vaccines done and the exact dose price are known. Another similar group enrolls in the reminder System. After the vaccination program is finished, the vaccination rate of patients with and without reminders is analyzed and compared. Costs are deduced and the average increase in net revenues is calculated.

By introducing the use of Systems that receive patient feedback, the performance management subsystem may also measure the degree of patient satisfaction and the effectiveness of the reminder System. Human or computerized intervention can be used if feedback is not within certain acceptance levels. For example, if the patient response or satisfaction with the program is below a certain level, the patient may be contacted.

Another possible intervention method may be the screening of the patient profile prior to enrollment in the program. In order to increase the patient response level, to improve the accuracy of the estimates and quality of the information gathered, tailor-made incentives and interventions can be designed depending on the patient health condition and hospitalization risk. For example, a high risk patient may be offered a big economic incentive upon vaccination or refill. Further analyses can be performed to correlate compliance, and feedback with the increase in vaccination rate of the reminder service.

FIG. 5 illustrates the incentive subsystem in accordance with an embodiment of the present invention. In an embodiment of the invention, the System may be capable of providing incentives to defray the costs of the alert service to the patient or to encourage adherence to a vaccination program. When the patient or caregiver sets up an alert, incentive information (e.g., notification of successful compliance with a vaccination regimen) is sent to the Incentive Daemon 501, which activates the Incentive Manager 502 and sends it data about the alert. The Incentive Manager 502 checks the incentive eligibility for the patient or the patients' vaccine and stores the relevant incentive information in the Incentive Database 503.

A number of incentives might be available upon the fulfillment of certain conditions. Incentives might be provided if a patient vaccinates on time, replies to a reminder message, vaccinates at a particular practitioner or hospital, or permits marketing material to be delivered with reminders. Incentives may include cash rebates, discounted premiums, or price discounts.

The Incentive Definitions Database 504 contains criteria defining when an incentive is awarded. These criteria may be set by the service provider, or the sponsor. The Incentive Definitions Database 504 has a table including the fields PATIENT_ID, DAY_SET, VACCINE/PRESCRIPTION_ID, VACCINE/REFILL_NUM and TOTAL_DOSES. PATIENT_ID and VACCINE/PRESCRIPTION_ID uniquely identify the patient and the vaccine/prescription; DAY_SET is the day when the alert was set; DOSE_NUM is the dose order out of the total number of doses of the vaccine/prescription program, which would be the value of TOTAL_DOSES. Whenever the Incentive Manager 502 receives a new alert, it queries the Incentive Definition Database 504 for past alerts with the same VACCINE/PRESCRIPTION_ID. If the patient had set a previous alert for the vaccine/prescription, this refill would qualify for an incentive.

A number of criteria may be used to verify that a patient has met the conditions required to receive an incentive award. The doctor, caregiver or other third party (such as an immunization registry) may use a software system to receive information about the vaccine/prescription payment/refill, automatically update the patient profile, and trigger award/payment orders. This software system may be accessed later by authorized third parties to check which incentives are applied to certain patients and which patients fulfilled the requirements. The verification may exist in the form of a vaccination proof (that later may be sent to the sponsor) or may be stored locally in a patient card. It also may be filled by the patient via the web (connected to the service provider database) or sent via regular mail to act as a rebate (e.g., ticket and barcode from the drug container). The patient may be issued a coupon that may be used to receive discounts at a retail store (which later may send the coupons to the program sponsor for reimbursement). The service provider may provide the verification in acknowledgement of a feedback message sent by the patient using the above-described feedback mechanism. In such a case, the service provider will acknowledge that the patient provided feedback by providing online verification, by electronic mail, a text message, or responding to the reminders by some other channel.

Once the requirement is fulfilled, there are several ways in which the award redemption may occur. A record generated by the caregiver may be sent to the service provider specifying the completion of the transaction. This record may be a computer record sent through a network to the computer system of the service provider, or caregiver may store the receipts and send them off-line in batches. When the transaction is executed, the patient is provided with the agreed award (e.g. $5 off the vaccine price).

If the incentive is not directly related to the payment at the caregiver's office (e.g., $2 off the insurance premium for the next month), verification of an award can be sent to the service provider to approve the award eligibility. The service provider can then pay the award to the patient (or ensure the award is paid) and bill the costs to the stakeholder sponsoring the incentive. If the incentive is point-based or similar, the service provider updates the patient records in the database system to reflect the award.

According to an embodiment of the present invention, incentive information is returned when an alert is set by the patient or caregiver at the point of service or information about an action (e.g., vaccination) is received. When the vaccination is performed, the System returns an acknowledgement message to the patient which includes information provided by the Incentives Manager 502 about the incentive that has been awarded. This message might give instructions to receive a cash refund. According to another embodiment of the present invention, incentive information is provided to the sponsor and then the sponsor provides the incentive. The service provider, in turn, would send the award information to the patient either one at a time or in a list.

The following examples show possible incentive scenarios that could be used in conjunction with the incentive subsystem described above:

### Example 1

The hospital offers over-the-shelf discounts if the patient agrees to vaccinate at the hospital facilities. The patient may see the incentive available at the hospital or by other mean (direct marketing, advertisement). The hospital is in charge of enrolling the patient in the system and the application is approved immediately. The hospital ties the incentives to opting-in to the reminder system that will send reminders to the user about how to follow the immunization program. If the patient gets vaccinated within a defined time frame, the hospital gives a $5 discount for the next vaccine. Since the only sponsor is the hospital, it acts as the service provider and is not required to exchange bill/reimbursement information with any other party.

### Example 2

The sponsor (Health Insurance Company) awards the patient directly. In this case the incentive may be a reduction of the premium cost in the insurance policy of a patient if she or he complies with the vaccination program (i.e., vaccinates on time). The sponsor here is the Health Insurance Company to which the patient belongs. The patient may be informed about the incentives available when enrolling in the vaccination program and into a patient compliance program or may be contacted by the service provider by any other means. When the application is approved, the service provider database will show that the patient will receive a $5 premium discount for each on-time vaccination. At vaccination time, the information is sent to the service provider. Then the health insurance company would gather the information of the premium of the patient and discount $5 from the next payment. Note that in this case the vaccination practitioner only provides information about payment/vaccination, and the award is granted from the sponsor to the patient directly (reduction in premium cost).

### Example 3

The Point of Service (hospital, doctor) provides the reimbursement but the sponsor is a third party (Health Insurance Company). This is similar to the last example, but the incentive is not a reduction in the premium but a discount on the price of the vaccine. The sponsor again is the Health Insurance Company to which the patient belongs and is the entity providing the incentive. The health insurance company may consider that its customer is less likely to require hospital visits or sick days if properly vaccinated and wants to provide an immediate reward to vaccination. The application process is identical to the last example. The difference in this case is that the point of service is no longer a static party just providing information but it is actually reducing the cost of the vaccine at the moment of vaccination. In this case the information is updated in the database of the service provider that the requirement is fulfilled. Then the point of service (hospital, doctor) will claim a reimbursement from the sponsor directly or through its Pharmacy Benefits Manager. The sponsor may also check that the requirements are met for the patient to be awarded. Finally, the sponsor proceeds to reimburse the point of service.

FIG. 6 illustrates the security system according to an embodiment of the present invention. The service provider network must be secure in order to reduce the possibility that external electronic attacks would threaten the integrity or confidentiality of patient data. Since prescription data is of a very sensitive nature, it is necessary to structure the network in a layered fashion where the critical applications and databases sit in the innermost layer.

Electronic messages generated at the point of service 600 arrive at the service provider's network through a firewall 601 that forms the first barrier to electronic attacks and at the same time allows a range of authorized transactions such as web server queries and email. From there, a router 602 directs messages either to the less critical part of the internal network 603 or to the more critical second layer of the network.

The second layer of the network is protected by a Firewall 604 which only admits messages related to the alert system. This reduces the possibility that malicious attacks can be launched against systems that have access to patient data. From the firewall 604 the message is passed to a gatekeeper server 605 that balances the load among the computers that run the different databases (e.g., 606, 607, and 608) and systems (e.g., 609). Load balancing is intended to enable easy system scalability where the increase of processing load can be distributed among a number of computers.

FIG. 7 illustrates the billing subsystem according to some embodiments of the present invention. For every billing cycle, the Billing Manager 700 gathers information from about the transactions performed from the Log Database 701. The Billing Manager 700 uses this information to generate bills which are stored in the Billing Database 702 for accounting purposes. The Billing Manager 700 may transmit these bills to the points of service or sponsors or the bills may be generated off-line by some other means. The Billing Manager 700 may also transmit billing information to other subsystems 703 such as the incentives or performance subsystems.

FIG. 8 illustrates the patient remote access system according to some embodiments of the present invention. Patients are provided remote access to the alert system by the remote access subsystem. A patient may wish to access the system for a number of reasons, including to review current alerts, change the status of current alerts, review or redeem incentives, or to review opt-in information.

Patients access the system through a Browser 800, which in some embodiments may be a web browser, but may also be any other application capable of communicating with the system on a PC, PDA, or cell phone.

The Report Server 801 establishes a secure connection with the Browser and authenticates the user against information from the Patient Database 802, typically a user name and password. The user name and password would be established when the patient subscribes for the service. The Report Server 801 can be a web server or any other application capable of communicating with the Browser 800 and conducting secure transactions.

Once the user has been authenticated, the Report Server 801 passes the user identity and any user queries to the Report Generator 803. Based on the user identity and user queries, the Report Generator 803 queries the Incentive Database 804, the Alert Database 805, and the Opt-in Database 806. The results of this query are used to construct a report that is returned to the Browser 800 through the Report Server 801. The report could be generated using standard tagged languages such as HTML or XML, or any language that is readable by Browser 800.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. For example, the reader is to understand that the specific ordering and combination of method steps described herein is merely illustrative, and the invention may be performed using different or additional method steps, or a different combination or ordering of method steps in a manner that does not depart from the spirit of the invention. For example, each feature of an embodiment may be mixed and matched with other features shown in other embodiments in a manner that does not depart from the spirit of the invention. Thus, the present inventions are intended to cover alternatives, modifications, and equivalents, which may be included within the spirit and scope of the present invention as defined by the claims.

What is claimed is:

1. A method of sending a healthcare alert to a subscriber, the method comprising:
receiving a message sent by a subscriber, the message comprising at least contact information of a patient and requesting a type of the healthcare alert;
processing the message;
determining a content of a healthcare alert to be sent to the subscriber based on the at least contact information of the patient and/or the type of the healthcare alert;
determining a proper time to send the healthcare alert to the subscriber; and
sending the healthcare alert with the proper content to the subscriber at the proper time.

2. The method of claim 1, wherein the healthcare alert is an immunization reminder.

3. The method of claim 1, wherein the healthcare alert is a medical appointment reminder

4. The method of claim 1, wherein the healthcare alert is a healthcare screening alert.

5. The method of claim 1, wherein the healthcare alert is a healthcare therapy reminder.

6. The method of claim 1, wherein the sending of the healthcare alert includes sending an email to the subscriber.

7. The method of claim 1, wherein the sending of the healthcare alert includes sending a wireless message to the subscriber.

8. The method of claim 1, wherein the sending of the healthcare alert includes sending a voicemail message to the subscriber's landline phone or mobile phone.

9. The method of claim 1, further comprising checking the subscriber's eligibility to receive the healthcare alert.

10. The method of claim 1, further comprising using feedback from the subscriber.

11. The method of claim 1, further comprising providing an incentive for the subscriber to send the message requesting the healthcare alert.

12. The method of claim 1, further comprising adding an educational message to the healthcare alert before sending the reminder to the subscriber.

13. A computer program product that includes a medium useable by a processor, the medium comprising a sequence of instructions which, when executed by the processor, causes the processor to execute a method of sending a healthcare alert to a subscriber, comprising:
receiving a message sent by a subscriber, the message comprising at least contact information of a patient and requesting a type of the healthcare alert;
processing the message;
determining a content of a healthcare alert to be sent to the subscriber based on the at least contact information of the patient and/or the type of the healthcare alert;
determining a proper time to send the healthcare alert to the subscriber; and
sending the healthcare alert with the proper content to the subscriber at the proper time.

14. The computer program product of claim 13, wherein the healthcare alert is an immunization reminder.

15. The computer program product of claim 13, wherein the healthcare alert is a medical appointment reminder

16. The computer program product of claim 13, wherein the healthcare alert is a healthcare screening alert.

17. The computer program product of claim 13, wherein the healthcare alert is a healthcare therapy reminder.

18. The computer program product of claim 13, wherein the sending of the healthcare alert is in an email to the subscriber.

19. The computer program product of claim 13, wherein the sending of the healthcare alert is in a wireless message to the subscriber.

20. The computer program product of claim 13, wherein the sending of the healthcare alert is in a voicemail message to the subscriber.

21. The computer program product of claim 13, further comprising checking the subscriber's eligibility to receive the healthcare alert.

22. The computer program product of claim 13, further comprising using feedback from the subscriber.

23. The computer program product of claim 13, further comprising providing an incentive for the subscriber to receive the healthcare alert.

24. A method of sending a healthcare reminder to a patient, the method comprising:
receiving contact information for the patient;
storing the patient's contact information;
determining a proper healthcare reminder to be sent to the patient;
determining a proper time to send the healthcare reminder to the patient; and
sending the healthcare reminder to the patient at the proper time.

25. The method of claim 24, wherein the healthcare reminder is an immunization reminder.

26. The method of claim 24, wherein the healthcare reminder is a medical appointment reminder

27. The method of claim 24, wherein the healthcare reminder is a screening alert.

28. The method of claim 24, wherein the healthcare reminder is a healthcare therapy reminder.

29. The method of claim 24, wherein the sending of the healthcare reminder includes sending an email to the patient.

30. The method of claim 24, wherein the sending of the healthcare reminder includes sending a wireless message to the patient.

31. The method of claim 24, wherein the sending of the healthcare reminder includes sending a voicemail message to the patient's phone.

32. The method of claim 24, further comprising providing the patient with a means for sending the patent's contact information to a database

33. The method of claim 24, further comprising providing healthcare personnel with a means for instructing the patient how to activate the reminders, wherein the means is physical or electronic.

34. The method of claim 32, wherein the providing step includes providing the patient with a phone number to call and a code to input over the phone.

35. The method of claim 32, further comprising inputting a code over a phone to identify a healthcare provider and sending personalized messages on behalf of the healthcare provider.

36. The method of claim 32, wherein the providing step includes providing the patient a device to send the patient's contact information to a database.

37. The method of claim 24, further comprising adding an educational message to the healthcare reminder before sending the reminder to the patient.

38. The method of claim 24, further comprising requesting feedback from the patient.

39. The method of claim 38, further comprising using the feedback from the patient to measure the performance of the method.

40. The method of claim 39, wherein the healthcare reminder is to get a vaccination and the feedback from the patient is used to measure a compliance rate for the patient or the vaccination.

41. The method of claim 39, further comprising modifying the content and/or timing of the healthcare reminder in order to improve the performance of the method.
